(19) United States
(12) Patent Application Publication
(10) Pub. No.: US 2026/0319412 A1
(43) Pub. Date: Oct. 15, 2026

(54) IMAGE FORMING APPARATUS CONTROL METHOD AND IMAGE FORMING APPARATUS

(71) Applicant: KYOCERA Document Solutions Inc., Osaka (JP)

(72) Inventors: Masaru Watanabe, Osaka (JP); Makoto Matsumoto, Osaka (JP); Yasuaki Sakamoto, Osaka (JP); Ayato Morikami, Osaka (JP); Yukiko Kotani, Osaka (JP)

(21) Appl. No.: 19/637,438

(22) Filed: Apr. 2, 2026

(30) Foreign Application Priority Data
Apr. 14, 2025 (JP) 2025-066120

(51) Int. Cl. G03G 15/00; G03G 15/01

(52) U.S. Cl. CPC G03G 15/5058; G03G 15/011; G03G 15/0131; G03G 15/0189; G03G 2215/00059

(57) ABSTRACT

A control device, in a case in which registered characteristic data representing a correspondence between a printing parameter and output image density is associated with a specific printing speed, derives a target printing parameter based on registered characteristic data, target image density, and a parameter calculation constant when a printing job corresponding to a target printing speed is started. The control device executes a parameter correction process while the printing job is being executed. The parameter correction process includes converting the registered characteristic data into target characteristic data corresponding to the target printing speed based on detected density of a test toner image by a density detection device, and deriving a corrected target printing parameter based on the target characteristic data and the target image density.

### INCORPORATION BY REFERENCE

This application is based upon and claims the benefit of priority from the corresponding Japanese Patent Application No. 2025-066120 filed on Apr. 14, 2025, the entire contents of which are incorporated herein by reference.

### BACKGROUND

The present disclosure relates to an image forming apparatus control method and an image forming apparatus that corrects a printing parameter according to a density of an output image.

In an electrophotographic image forming apparatus, various types of printing parameters are set so as to obtain an output image of appropriate density. For example, the printing parameters include a charging voltage for charging a photoconductor, a developing bias voltage, or a light beam amount that is scanned onto the photoconductor.

On the other hand, when a printing job is executed, the image forming apparatus executes the printing process at different printing speeds depending on whether color printing or monochrome printing is performed, or on a thickness of a sheet, or the like.

The image forming apparatus rotates the photoconductor and a plurality of rotating members linked to the photoconductor at a speed corresponding to the printing speed.

Specifically, the image forming apparatus rotates a plurality of conveying rollers that convey the sheet at a speed corresponding to the printing speed. In addition, the image forming apparatus may include an intermediate transfer member to which a toner image is transferred from the photoconductor and that transfers the toner image to the sheet. In this case, the image forming apparatus rotates the intermediate transfer member at a speed corresponding to the printing speed.

A value of a printing parameter for obtaining the output image with an appropriate density may vary depending on the printing speed.

For example, it is known that the image forming apparatus detects a density of a test image under two conditions with different printing speeds, and sets a printing parameter for each printing speed according to the detected density.

### SUMMARY

An image forming apparatus control method according to one aspect of the present disclosure is a method for controlling an image forming apparatus. The image forming apparatus includes a printing device and a density detection device. The printing device, including a rotating image-carrying member, forms a toner image on a surface of the image-carrying member, and transfers the toner image on the image-carrying member onto each of a plurality of sheets conveyed along a conveying path. The density detection device detects density of a test toner image formed on a surface of the image-carrying member. The image forming apparatus control method includes: in a case in which registered characteristic data representing a correspondence relationship between a printing parameter of the printing device and output image density is associated with a specific printing speed, a control device, when a printing job is started in which an image is transferred onto each of the plurality of sheets while rotating the image-carrying member at a speed corresponding to a target printing speed different from the specific printing speed, executing an initial parameter setting process to initially set a target printing parameter corresponding to the target printing speed in the printing device. Furthermore, the image forming apparatus control method includes the control device, while the printing job is being executed, executing a parameter correction process for correcting the printing parameter set in the printing device. The initial parameter setting process includes: the control device deriving the target printing parameter based on the registered characteristic data, a target image density, and a parameter calculation constant. Furthermore, the initial parameter setting process includes the control device setting the derived target printing parameter in the printing device. The parameter correction process includes the control device causing the printing device to execute a process of forming the test toner image in an invalid area on the surface of the image-carrying member other than a transfer area where the toner image is transferred onto each of the plurality of sheets. Moreover, the parameter correction process includes the control device converting the registered characteristic data into target characteristic data corresponding to the target printing speed based on detected density of the test toner image detected by the density detection device. Furthermore, the parameter correction process includes the control device deriving a corrected target printing parameter based on the target characteristic data and the target image density. The parameter correction process further includes the control device setting the corrected target printing parameter in the printing device.

An image forming apparatus according to another aspect of the present disclosure includes the printing device, the density detection device, and the control device that implements the image forming apparatus control method.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus according to an embodiment.

FIG. 2 is a diagram showing a configuration of a charging device and a developing device in an image forming apparatus according to an embodiment.

FIG. 3 is a block diagram showing a configuration of a control device in an image forming apparatus according to an embodiment.

FIG. 4 is a flowchart showing an example of a procedure for controlling printing parameters in an image forming apparatus according to an embodiment.

FIG. 5 is a flowchart showing an example of a procedure for a first initial parameter setting process in an image forming apparatus according to an embodiment.

FIG. 6 is a flowchart showing an example of a procedure of a second initial parameter setting process in an image forming apparatus according to an embodiment.

FIG. 7 is a flowchart showing an example of a procedure for a parameter correction process in an image forming apparatus according to an embodiment.

FIG. 8 is a graph showing an example of registered characteristic data in an image forming apparatus according to an embodiment.

FIG. 9 is a graph showing an example of registered characteristic data and corrected registered characteristic data in an image forming apparatus according to an embodiment.

FIG. 10 is a graph showing an example of registered characteristic data and target characteristic data in an image forming apparatus according to an embodiment.

### DETAILED DESCRIPTION

Hereinafter, an embodiment according to the present disclosure will be described with reference to the drawings. Note that the following embodiments are examples of a specific embodiment according the present disclosure, and do not limit the technical scope of the present disclosure.

### Configuration of Image Forming Apparatus 10

An image forming apparatus 10 according to an embodiment is an apparatus that executes a printing process by an electrophotographic method. The printing process is a process in which an image is formed on a sheet 9. The sheet 9 is an image forming medium such as paper or a resin sheet.

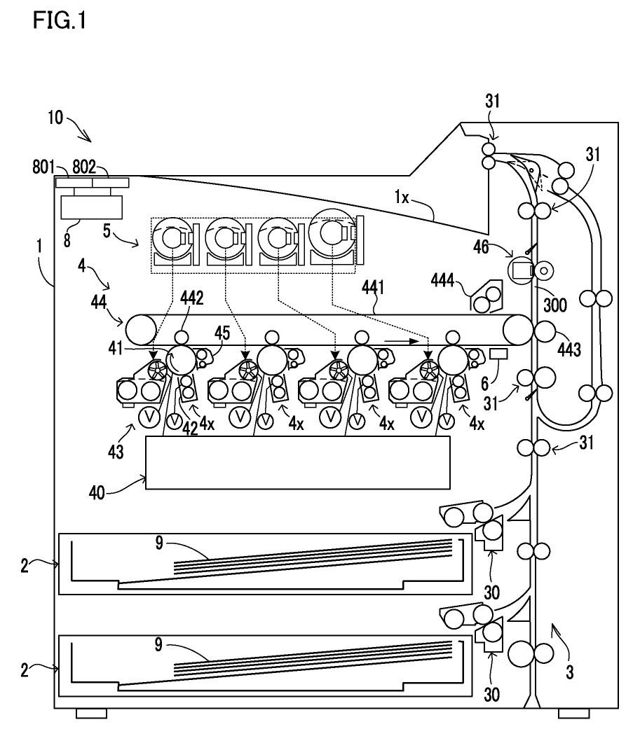

The image forming apparatus 10 shown in FIG. 1 is a printer. Note that the image forming apparatus 10 may be a copier, a facsimile machine, a multifunction peripheral, or the like.

As shown in FIG. 1, the image forming apparatus 10 includes a main housing 1, a sheet storing portion 2, a conveying device 3, a printing device 4, a toner supplying device 5, a control device 8, an operating device 801, and a display device 802.

The conveying device 3, the printing device 4, the toner supplying device 5 and the control device 8 are housed in the main housing 1. A conveying path 300 for the sheet 9 is provided inside the main housing 1.

The conveying device 3 includes a sheet feeding mechanism 30 and a plurality of sets of conveying roller pairs 31. The sheet feeding mechanism 30 feeds each of the plurality of sheets 9 stored in the sheet storing portion 2 to the conveying path 300.

The plurality of sets of conveying roller pairs 31 convey each sheet 9 along the conveying path 300. One set of the plurality of sets of conveying roller pairs 31 discharges each sheet 9 on which an image has been formed by the printing device 4 from the conveying path 300 onto the discharge tray 1x.

The printing device 4 executes the printing process on each sheet 9 conveyed along the conveying path 300 by the electrophotographic method.

The printing device 4 includes a laser scanning unit 40, one or more image forming portions 4x, a transfer device 44, and a fixing device 46. The printing device 4 shown in FIG. 1 is a tandem color printing device. In this case, the printing device 4 includes a plurality of image forming portions 4x corresponding to a plurality of developing colors.

In the example shown in FIG. 1, the printing device 4 includes four image forming portions 4x corresponding to the developing colors of yellow, magenta, cyan, and black.

The plurality of image forming portions 4x include a plurality of photoconductors 41, a plurality of charging devices 42, a plurality of developing devices 43, and a plurality of drum cleaning devices 45. Each photoconductor 41 rotates, and each charging device 42 charges a surface of the photoconductor 41.

The laser scanning unit 40 scans a light beam across the charged surface of the photoconductor 41 to form an electrostatic latent image on the surface of the photoconductor 41. In the present embodiment, the light beam is a laser beam.

Each developing device 43 supplies toner to the surface of each photoconductor 41 to develop the electrostatic latent image into a toner image.

The transfer device 44 transfers the toner images on the surfaces of the plurality of photoconductors 41 onto each of the sheets 9 conveyed along the conveying path 300.

In the tandem printing device 4, the transfer device 44 includes an intermediate transfer belt 441, a plurality of primary transfer devices 442, a secondary transfer device 443, and a belt cleaning device 444. The plurality of primary transfer devices 442 are provided corresponding to the plurality of photoconductors 41.

The intermediate transfer belt 441 rotates with a portion thereof in contact with the surfaces of the plurality of photoconductors 41. Each primary transfer device 442 transfers the toner image on the surface of each photoconductor 41 onto the surface of the intermediate transfer belt 441. Thus, a color toner image, which is a composite of the toner images of a plurality of colors, is formed on the surface of the intermediate transfer belt 441.

The secondary transfer device 443 transfers the color toner image on the surface of the intermediate transfer belt 441 onto each of the plurality of sheets 9 conveyed along the conveying path 300. That is, the transfer device 44 transfers the toner image on the surface of the photoconductor 41 onto the sheet 9 via the intermediate transfer belt 441.

The intermediate transfer belt 441 is an example of an intermediate transfer member. The intermediate transfer belt 441 is also an example of an image-carrying member that rotates while carrying the toner image.

The fixing device 46 applies heat and pressure to the color toner image on the sheet 9 to fix the color toner image to the sheet 9.

The toner supplying device 5 supplies toner to each of the developing devices 43.

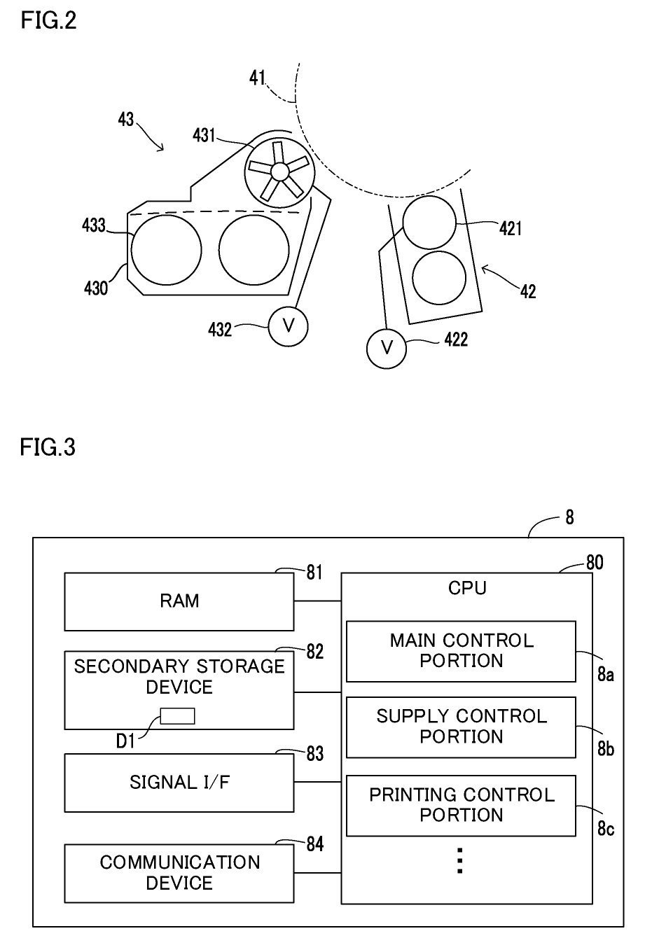

The plurality of charging devices 42 include a plurality of charging rollers 421 and a charging voltage output device 422 that applies a charging voltage to the plurality of charging rollers 421 (see FIG. 2). The plurality of charging rollers 421 are arranged facing the plurality of photoconductors 41, respectively. Each charging roller 421 charges the surface of each photoconductor 41. Each charging roller 421 is an example of a charging body.

The plurality of developing devices 43 each include a plurality of developing agent storage portions 430, a plurality of developing rollers 431, and a developing voltage output device 432 (see FIG. 2). The plurality of developing rollers 431 are arranged facing the plurality of photoconductors 41, respectively.

Each of the developing agent storage portions 430 stores developing agent including the toner. The developing voltage output device 432 applies a developing voltage to the plurality of developing rollers 431. The developing voltage is a bias voltage applied to each developing roller 431 with a potential of each photoconductor 41 as a reference.

Each of the developing rollers 431 carries the toner and rotates. Each developing device 43, by supplying the toner to the surface of each photoconductor 41 by each developing roller 431, develops the electrostatic latent image on the surface of each photoconductor 41 into the toner image. The plurality of developing rollers 431 is an example of a plurality of developing members.

Furthermore, the developing device 43 includes a developing agent stirring member 433 (see FIG. 2). The developing agent stirring member 433 rotates inside the developing agent storage portion 430 to stir the developing agent.

The operation device 801 is a device that receives human operations. For example, the operation device 801 includes one or both of a touch panel and operation buttons.

The display device 802 is capable of displaying various types of information. For example, the display device 802 is a panel display device such as a liquid crystal display device. The control device 8 controls various types of electrical devices included in the image forming apparatus 10.

As shown in FIG. 3, the control device 8 includes a central processing unit (CPU) 80, a random access memory (RAM) 81, a secondary storage device 82, a signal interface 83, a communication device 84, and the like.

The CPU 80 is an example of a processor that executes various types of control and data processing functions by executing computer programs. The RAM 81 temporarily stores the computer programs executed by the CPU 80 and various types of data.

The secondary storage device 82 is a computer-readable non-volatile storage device. The secondary storage device 82 stores the computer programs executed by the CPU 80 and various types of data. For example, one or both of a flash memory and a hard disk drive may be employed as the secondary storage device 82.

The signal interface 83 converts detection signals of various types of sensors into digital detection data. The detection data is transmitted to the CPU 80.

The communication device 84 executes communication with one or more host devices via a network. The CPU 80 executes communication with the host device via a communication device 84. The host device is an information processing apparatus that requests the image forming apparatus 10 to perform the printing process.

The CPU 80 includes a plurality of processing modules that are implemented by executing the computer programs. The plurality of processing modules include a main control portion 8a, a supply control portion 8b, a printing control portion 8c, and the like (see FIG. 2).

The main control portion 8a executes control that causes other modules to execute processing of receiving various types of requests and processing according to the requests. For example, the main control portion 8a receives a printing job request via the operation device 801 or the communication device 84, and transmits the printing job request to the printing control portion 8c.

The supply control portion 8b, by controlling the toner supplying device 5, controls the supply of toner from the toner supplying device 5 to the printing device 4.

The printing control portion 8c controls the conveying device 3 and the printing device 4. Thus, the printing control portion 8c causes the conveying device 3 and the printing device 4 to execute the printing job. In the printing job, the printing control portion 8c causes the conveying device 3 to convey each of the plurality of sheets 9, and further causes the printing device 4 to execute the printing process on each of the sheets 9.

When the printing job is executed, the printing control portion 8c causes the printing device 4 to execute the printing process at different printing speeds depending on whether color printing or monochrome printing is being executed, the thickness of the sheet 9, or the like.

In the printing job, the printing control portion 8c causes the transfer device 44 to execute a process of transferring an image onto each of the plurality of sheets 9 while rotating the plurality of photoconductors 41 and a plurality of rotating members linked to the plurality of photoconductors 41 at a speed corresponding to the printing speed.

The plurality of rotating members include a plurality of sets of conveying roller pairs 31 and an intermediate transfer belt 441.

The printing control portion 8c sets various types of printing parameters so that an output image of appropriate density can be obtained. For example, the printing parameters are the charging voltage of each charging device 42, the developing voltage of each developing device 43, the light beam amount in the laser scanning unit 40, and the like.

The printing parameters may also be timing parameters in the laser scanning unit 40. The timing parameters are parameters that determine timing of scanning the light beams on each of the plurality of photoconductors 41. In a case in which the timing of scanning the light beams on each of the plurality of photoconductors 41 is out of sync, the density of the output image will decrease.

A value of a printing parameter for obtaining the output image with an appropriate density may vary depending on the printing speed.

In the image forming apparatus 10, an appropriate printing parameter may vary depending on conditions such as usage environment and deterioration over time. Therefore, it is desirable that the printing parameter be adjusted each time a predetermined condition related to a number of prints or elapsed time is met.

On the other hand, in a case in which the printing parameter is adjusted under each of a plurality of conditions with different printing speeds every time the predetermined condition is met, downtime during which the printing job cannot be executed increases.

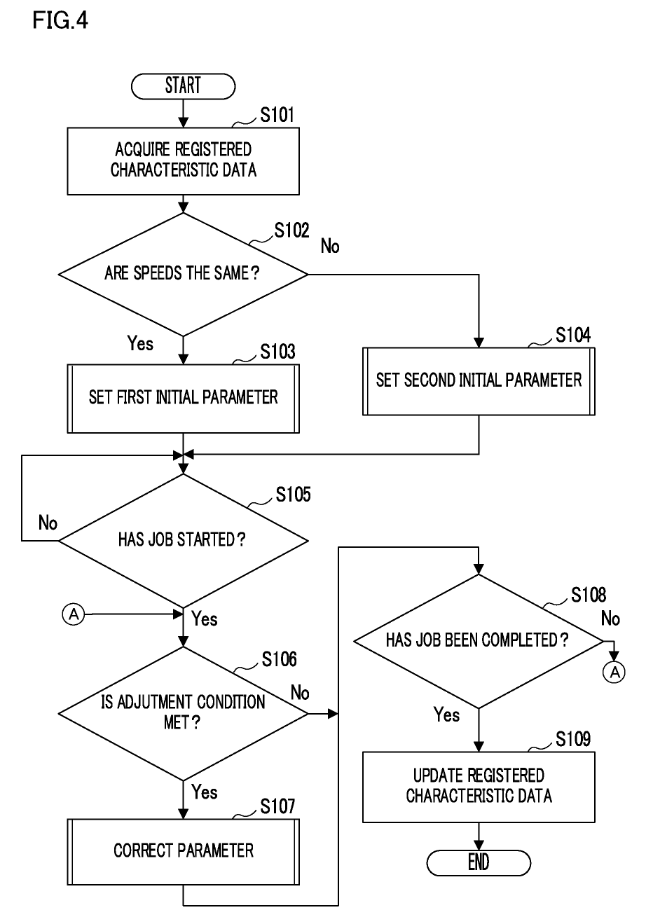

The printing control portion 8c executes printing parameter control, which will be described later (see FIG. 4). Thus, the printing control portion 8c performs adjustment of the printing parameter to correspond to a plurality of printing speeds without increasing downtime.

The image forming apparatus 10 further includes a density detection device 6 used for the printing parameter control (see FIG. 1).

In the present embodiment, the density detection device 6 detects density of a test toner image formed on the surface of the intermediate transfer belt 441. The test toner image may be a uniform solid image, a shaded image, or an image with a uniform pattern.

For example, the density detection device 6 is one or more reflective photosensors. In this case, the density detection device 6 irradiates the surface of the intermediate transfer belt 441 with light and detects an amount of diffused reflected light reflected by the surface of the intermediate transfer belt 441.

### Printing Parameter Control

An example of a procedure of the printing parameter control will be described below with reference to the flowchart shown in FIG. 4.

The printing control portion 8c starts the printing parameter control when the printing job request is received. In the following description, the speed adopted for the printing job from among a plurality of candidates for the printing speed will be referred to as a target printing speed.

When executing the printing job, the printing device 4 transfers the toner image onto each of the plurality of sheets 9 while rotating the plurality of photoconductors 41 and the intermediate transfer belt 441 at a speed corresponding to the target printing speed.

The control device 8 including the printing control portion 8c is an example of a device that controls the image forming apparatus 10. The printing parameter control is an example of a process that implements an image forming apparatus control method. That is, the control device 8 is an example of a device that implements the image forming apparatus control method.

In the following description, S101, S102, . . . represent identification codes of a plurality of steps in the printing parameter control. In the printing parameter control, first, the process of step S101 is executed.

### Step S101

In step S101, the printing control portion 8c acquires registered characteristic data D1 associated with any one of the plurality of candidates for the printing speed. The registered characteristic data D1 is stored in the secondary storage device 82 (see FIG. 3).

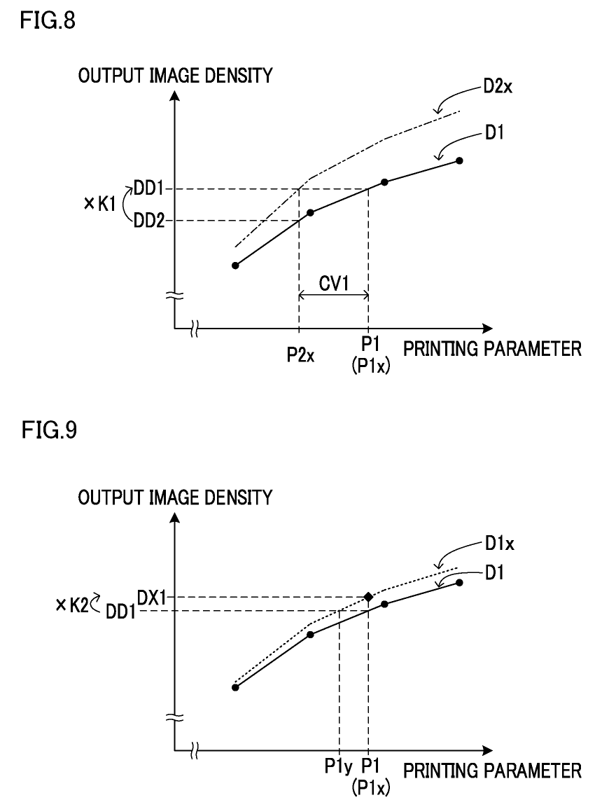

The registered characteristic data D1 represents a correspondence between the printing parameter of the printing device 4 and output image density (see FIG. 8). As described above, the printing parameter includes the charging voltage of each charging device 42, the developing voltage of each developing device 43, the light beam amount of the laser scanning unit 40, or the timing parameter of the laser scanning unit 40.

In the following description, the speed among the plurality of candidates for the printing speed that is associated with the registered characteristic data D1 will be referred to as a specific printing speed.

After executing the process of step S101, the printing control portion 8c executes the process of step S102.

### Step S102

In step S102, the printing control portion 8c determines whether the target printing speed is the same as or different from the specific printing speed.

When the target printing speed is the same as the specific printing speed, the printing control portion 8c executes the process of step S103. On the other hand, when the target printing speed is different from the specific printing speed, the printing control portion 8c executes the process of step S104.

### Step S103

In step S103, the printing control portion 8c executes a first initial parameter setting process, which will be described later (see FIG. 5). The first initial parameter setting process is a first example of a process for initially setting target printing parameter corresponding to the target printing speed in the printing device 4.

After executing the process of step S103, the printing control portion 8c executes the process of step S105.

### Step S104

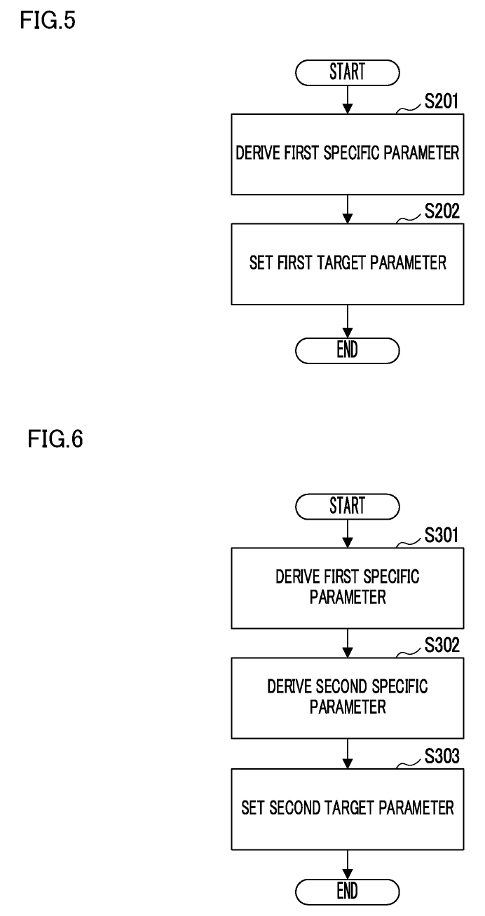

In step S104, the printing control portion 8c executes a second initial parameter setting process, which will be described later (see FIG. 6). The second initial parameter setting process is a second example of a process for initially setting the target printing parameter corresponding to the target printing speed in the printing device 4.

The second initial parameter setting process also includes a process of converting the registered characteristic data D1 into target characteristic data D2 corresponding to the target printing speed (see FIGS. 6 and 9).

After executing the process of step S104, the printing control portion 8c executes the process of step S105.

The processes of steps S101 to S104 are processes before the printing job is started. The printing control portion 8c executes a preparation process for the printing job in parallel with the processes of steps S101 to S104.

Furthermore, when the preparation process is completed, the printing control portion 8c causes the printing device 4 to execute the printing job. At that time, the printing control portion 8c causes the printing device 4 to execute the printing job in a state in which the printing parameter has been set in the printing device 4 by the process of step S103 or step S104.

### Step S105

In step S105, the printing control portion 8c waits until the printing job is started. The printing control portion 8c executes the process of step S106 when the printing job is started.

The printing control portion 8c executes the processes from step S106 onwards while causing the printing device 4 to execute the printing job.

### Step S106

In step S106, the printing control portion 8c selects the next process depending on whether an adjustment condition is met or not. The adjustment condition is a preset condition relating to the number of prints or elapsed time.

For example, the adjustment condition is a condition that the number of prints from the start of the printing job or the time when the adjustment condition was last met reaches a predetermined reference number. In addition, the adjustment condition may be such that the time elapsed from the start of the printing job or from the time the adjustment condition was previously satisfied reaches a predetermined reference time.

In a case in which the adjustment condition is not met, the printing control portion 8c executes the process of step S108. On the other hand, the printing control portion 8c executes the process of step S107 every time the adjustment condition is met while the printing job is being executed.

### Step S107

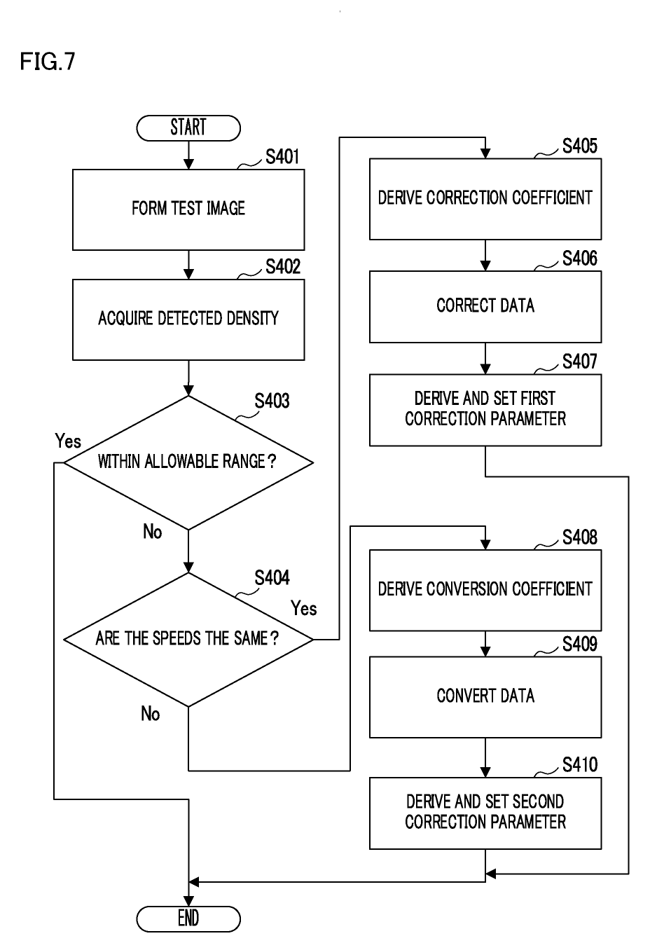

In step S107, the printing control portion 8c executes a parameter correction process, which will be described later (see FIG. 7). The parameter correction process includes a process of correcting the printing parameter set in the printing device 4.

In a case in which the target printing speed is the same as the specific printing speed, the parameter correction process includes a process of correcting the registered characteristic data D1 (see FIGS. 7 and 9). Corrected registered characteristic data D1x is obtained by correcting the registered characteristic data D1 (see FIG. 9).

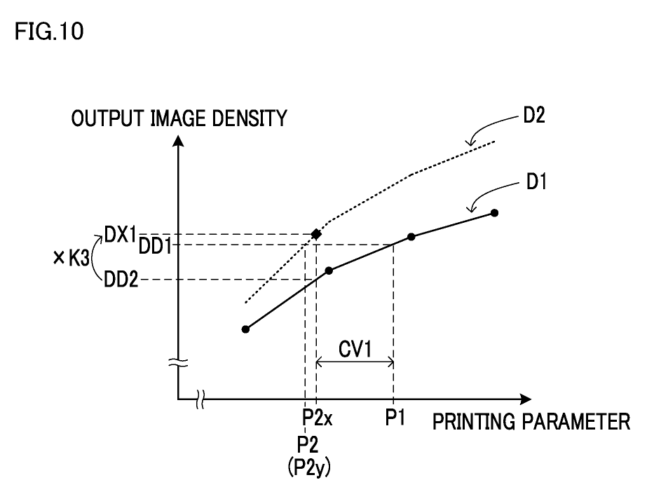

On the other hand, in a case in which the target printing speed is different from the specific printing speed, the parameter correction process includes converting the registered characteristic data D1 into target characteristic data D2 corresponding to the target printing speed (see FIGS. 7 and 10).

After executing the process of step S107, the printing control portion 8c executes the process of step S108.

### Step S108

In step S108, the printing control portion 8c selects the next process depending on whether the printing job has been completed or not.

When the printing job has not yet been completed, the printing control portion 8c executes the processes from step S106 onwards. On the other hand, when the printing job is completed, the printing control portion 8c executes the process of step S109.

### Step S109

In step S109, the printing control portion 8c executes a process of updating the registered characteristic data D1 to the data obtained by the parameter correction process in step S107.

In a case in which the registered characteristic data D1 is corrected in the parameter correction process, the printing control portion 8c updates the registered characteristic data D1 to corrected registered characteristic data D1x. In this case, the printing speed associated with the registered characteristic data D1 is not changed before and after the update of the registered characteristic data D1.

On the other hand, in a case in which the registered characteristic data D1 is converted into the target characteristic data D2 in the parameter correction process, the printing control portion 8c updates the registered characteristic data D1 to the target characteristic data D2. In this case, the printing speed associated with the registered characteristic data D1 is changed from the specific printing speed to the target printing speed.

After executing the process of step S109, the printing control portion 8c ends the printing parameter control.

### First Initial Parameter Setting Process

Next, an example of a procedure of the first initial parameter setting process will be described with reference to the flowchart shown in FIG. 5.

In the following description, S201 and S202 represent identification codes of two steps in the first initial parameter setting process. In the first initial parameter setting process, first, the process of step S201 is executed.

### Step S201

In step S201, the printing control portion 8c derives a first specific printing parameter P1 corresponding to the target image density DD1 in the printing parameter of the registered characteristic data D1 (see FIG. 8).

After executing the process of step S201, the printing control portion 8c executes the process of step S202.

### Step S202

In step S202, the printing control portion 8c sets the first specific printing parameter P1 obtained in step S201 as the first target parameter P1x in the printing device 4 (see FIG. 8). The first target parameter P1x is the initial value of the target parameter when the target printing speed is the same as the specific printing speed.

After executing the process of step S202, the printing control portion 8c ends the first initial parameter setting process.

The printing control portion 8c causes the printing device 4 to execute the printing job in a state in which the printing parameter has been set in the printing device 4 by the first initial parameter setting process.

### Second Initial Parameter Setting Process

Next, an example of a procedure of a second initial parameter setting process will be described with reference to the flowchart shown in FIG. 6.

In the following description, S301, S302, . . . represent identification codes of a plurality of steps in the second initial parameter setting process. In the second initial parameter setting process, first, the process of step S301 is executed.

### Step S301

In step S301, the printing control portion 8c derives a first specific printing parameter P1 corresponding to a target image density DD1 in the printing parameter of the registered characteristic data D1 (see FIG. 8).

After executing the process of step S301, the printing control portion 8c executes the process of step S302.

### Step S302

In step S302, the printing control portion 8c derives a second target parameter P2x based on the first specific printing parameter P1 obtained in step S301 and a preset parameter calculation constant CV1. A second target parameter P2x is an initial value of the target parameter when the target printing speed is different from the specific printing speed.

In the present embodiment, the parameter calculation constant CV1 is an offset value that represents a difference with respect to the first specific printing parameter P1. In this case, the printing control portion 8c derives the difference between the first specific printing parameter P1 and the parameter calculation constant CV1 as the second target parameter P2x (see FIG. 8).

Here, density corresponding to the second target parameter P2x in the output image density of the registered characteristic data D1 is referred to as a reference image density DD2 (see FIG. 8). In addition, a ratio of the target image density DD1 to the reference image density DD2 is referred to as an assumed conversion coefficient K1 (see FIG. 8).

Moreover, characteristic data obtained by multiplying the output image density in the registered characteristic data D1 by the assumed conversion coefficient K1 is referred to as assumed target characteristic data D2x (see FIG. 8).

In a case in which the target printing speed is different from the specific printing speed, the printing control portion 8c sets the printing parameter of the printing device 4 under the assumption that the assumed target characteristic data D2x is characteristic data corresponding to the target printing speed.

Note that the parameter calculation constant CV1 may be the assumed conversion coefficient K1. In this case, in step S302, the printing control portion 8c converts the registered characteristic data D1 into the assumed target characteristic data D2x based on the assumed conversion coefficient K1. Furthermore, the printing control portion 8c derives a parameter corresponding to the target image density DD1 in the printing parameter of the assumed target characteristic data D2x as a second target parameter P2x.

After executing the process of step S302, the printing control portion 8c executes the process of step S303.

### Step S303

In step S303, the printing control portion 8c sets the second target parameter P2x obtained in step S302 in the printing device 4.

After executing the process of step S303, the printing control portion 8c ends the second initial parameter setting process.

The printing control portion 8c causes the printing device 4 to execute the printing job in a state in which the printing parameter has been set in the printing device 4 by the second initial parameter setting process.

### Parameter Correction Process

Next, an example of a procedure for the parameter correction process will be described with reference to the flowchart shown in FIG. 7.

In the following description, S401, S402, and so on represent identification codes of a plurality of steps in the parameter correction process. In the parameter correction process, first, the process of step S401 is executed.

### Step S401

In step S401, the printing control portion 8c causes the printing device 4 to execute a test image forming process. The test image forming process is a process of forming the test toner image in an invalid area on the surface of the intermediate transfer belt 441.

The invalid area is an area on the surface of the intermediate transfer belt 441 other than a transfer area where the toner image is transferred onto each of the plurality of sheets 9. For example, the invalid area is an area outside the transfer area in a main scanning direction, or an area corresponding to a gap between two successive sheets 9.

After executing the process of step S401, the printing control portion 8c executes the process of step S402.

### Step S402

In step S402, the printing control portion 8c acquires a detected density DX1, which is a density of the test toner image detected by the density detection device 6 (see FIG. 9).

After executing the process of step S402, the printing control portion 8c executes the process of step S403.

### Step S403

In step S403, the printing control portion 8c selects the next process depending on whether the detected density DX1 is within an allowable range based on the target image density DD1 or outside the allowable range.

In a case in which the detected density DX1 is within the allowable range, the printing control portion 8c ends the parameter correction process. On the other hand, in a case in which the detected density DX1 is outside the allowable range, the printing control portion 8c executes the process of step S404.

### Step S404

In step S404, the printing control portion 8c selects the next process depending on whether the target printing speed is the same as or different from the specific printing speed.

When the target printing speed is the same as the specific printing speed, the printing control portion 8c executes the process of step S405. On the other hand, when the target printing speed is different from the specific printing speed, the printing control portion 8c executes the process of step S408.

### Step S405

In step S405, the printing control portion 8c derives a correction coefficient K2, which is a coefficient for correcting the registered characteristic data D1, based on the detected density DX1 (see FIG. 9).

In the present embodiment, the correction coefficient K2 is a ratio of the detected density DX1 to the target image density DD1.

After executing the process of step S405, the printing control portion 8c executes the process of step S406.

### Step S406

In step S406, the printing control portion 8c corrects the registered characteristic data D1 based on the correction coefficient K2. Thus, corrected registered characteristic data D1x is obtained (see FIG. 9).

In the present embodiment, the printing control portion 8c derives corrected registered characteristic data D1x by multiplying the output image density in the registered characteristic data D1 by a correction coefficient K2 (see FIG. 9).

After executing the process of step S406, the printing control portion 8c executes the process of step S407.

### Step S407

In step S407, the printing control portion 8c derives a first correction parameter P1y based on the corrected registered characteristic data D1x and the target image density DD1, and sets the first correction parameter P1y in the printing device 4 (see FIG. 9). The first correction parameter P2y is a corrected first target parameter P2x.

More specifically, the printing control portion 8c derives the parameter corresponding to the target image density DD1 in the printing parameter of the corrected registered characteristic data D1x as the first correction parameter P1y (see FIG. 9).

After executing the process of step S407, the printing control portion 8c ends the parameter correction process.

### Step S408

On the other hand, in step S408, the printing control portion 8c derives a conversion coefficient K3 used to convert the registered characteristic data D1 into target characteristic data D2 corresponding to the target printing speed based on the detected density DX1 (see FIG. 10).

More specifically, the printing control portion 8c derives the reference image density DD2 corresponding to the second target parameter P2x in the output image density of the registered characteristic data D1 (see FIG. 10).

Furthermore, the printing control portion 8c derives a ratio of the detected density DX1 to the reference image density DD2 as the conversion coefficient K3 (see FIG. 10).

After executing the process of step S408, the printing control portion 8c executes the process of step S409.

### Step S409

In step S409, the printing control portion 8c, based on the conversion coefficient K3, converts the registered characteristic data D1 into target characteristic data D2 corresponding to the target printing speed (see FIG. 10).

More specifically, the printing control portion 8c derives the target characteristic data D2 by multiplying the output image density in the registered characteristic data D1 by the conversion coefficient K3 (see FIG. 10).

After executing the process of step S409, the printing control portion 8c executes the process of step S410.

### Step S410

In step S410, the printing control portion 8c derives a second correction parameter P2y based on the target characteristic data D2 and the target image density DD1, and sets the second correction parameter P2y in the printing device 4 (see FIG. 10). The second correction parameter P1y is a corrected first target parameter P1x.

More specifically, the printing control portion 8c derives the second specific printing parameter P2 corresponding to the target image density DD1 in the printing parameter of the target characteristic data D2 as the second correction parameter P2y (see FIG. 10).

After executing the process of step S410, the printing control portion 8c ends the parameter correction process.

As described above, when the printing job corresponding to the target printing speed that is the same as the specific printing speed is started under circumstances where the registered characteristic data D1 is associated with the specific printing speed, the printing control portion 8c executes the first initial parameter setting process (see steps S102, S103, S201, and S202).

In the first initial parameter setting process, the printing control portion 8c sets the first specific printing parameter P1 corresponding to the target image density DD1 in the printing parameter of the registered characteristic data D1 as the target printing parameter in the printing device 4 (see S201, S202).

That is, when the target printing speed is the same as the specific printing speed corresponding to the registered characteristic data D1, the printing control portion 8c sets the target printing parameter in the printing device 4 based on the registered characteristic data D1 and the target image density DD1.

On the other hand, when the printing job corresponding to the target printing speed that is different from the specific printing speed is started under a condition that the registered characteristic data D1 is associated with the specific printing speed, the printing control portion 8c executes the second initial parameter setting process (see steps S102, S104, S301 to S303).

In the second initial parameter setting process, the printing control portion 8c derives the second target parameter P2x based on the registered characteristic data D1, the target image density DD1, and the parameter calculation constant CV1 (see step S302). Furthermore, the printing control portion 8c sets the derived second target parameter P2x in the printing device 4 (see step S303).

Moreover, after executing the second initial parameter setting process, the printing control portion 8c executes the parameter correction process to correct the printing parameter set in the printing device 4 while the printing job is being executed (see steps S107, S401, S402, S408 to S410).

In the parameter correction process, the printing control portion 8c causes the printing device 4 to execute a process of forming the test toner image in the invalid area on the surface of the intermediate transfer belt 441 (see step S401).

Furthermore, in the parameter correction process, the printing control portion 8c converts the registered characteristic data D1 into target characteristic data D2 corresponding to the target printing speed based on the detected density of the test toner image (see steps S408 and S409).

Furthermore, in the parameter correction process, the printing control portion 8c, based on the target characteristic data D2 and the target image density DD1, derives the second correction parameter P2y, which is the corrected target printing parameter (see step S410). The printing control portion 8c further sets the second correction parameter P2y in the printing device 4 (see step S410).

By adopting the printing parameter control, even in a case in which the specific printing speed corresponding to the registered characteristic data D1 is different from the target printing speed corresponding to the printing job, there is no need to delay the start of the printing job in order to set the target characteristic data.

In addition, there is no need to interrupt the printing job to adjust the target characteristic data every time the adjustment condition is met during the execution of the printing job.

Therefore, by adopting the printing parameter control, it is possible to adjust the printing parameter to accommodate a plurality of printing speeds without increasing downtime.

In addition, in a case in which the specific printing speed is different from the target printing speed, the printing control portion 8c associates the target characteristic data D2 with the target printing speed and sets it as new registered characteristic data D1 (see step S109).

Therefore, even in a case in which the printing device 4 deteriorates over time, the printing parameter of the printing device 4 is set based on the registered characteristic data D1 that reflects the most recent state of the printing device 4.

### Modification

Next, a modification of the image forming apparatus 10 will be described.

In the present modification, the printing device 4 is a device dedicated to monochrome printing. In the modification, a transfer device 44 includes a photoconductor 41 and a primary transfer device 442 arranged along a conveying path 300. In this case, the primary transfer device 442 transfers a toner image formed on the surface of the photoconductor 41 onto a sheet 9.

In the present modification, a density detection device 6 detects a test toner image formed in an invalid area of the photoconductor 41. In the present modification, the photoconductor 41 is an example of an image-carrying member.

In the present modification, the printing parameter includes a charging voltage in a charging device 42, a light beam amount in a laser scanning unit 40, or a developing voltage in a developing device 43.

### Supplementary Notes

An outline of the technique according to the disclosure extracted from the above-described embodiments will be added below. Note that the configurations and processing functions described in the following supplementary notes can be selected and combined as desired.

### Supplementary Note 1

An image forming apparatus control method for controlling an image forming apparatus,
the image forming apparatus including:
a printing device including a rotating image-carrying member and configured to form a toner image on a surface of the image-carrying member, and transfer the toner image on the image-carrying member onto each of a plurality of sheets conveyed along a conveying path; and
a density detection device configured to detect density of a test toner image formed on a surface of the image-carrying member;
the image forming apparatus control method including:
in a case in which registered characteristic data representing a correspondence relationship between a printing parameter of the printing device and output image density is associated with a specific printing speed,
a control device, when a printing job is started in which an image is transferred onto each of the plurality of sheets while rotating the image-carrying member at a speed corresponding to a target printing speed different from the specific printing speed, executing an initial parameter setting process to initially set a target printing parameter corresponding to the target printing speed in the printing device; and
the control device, while the printing job is being executed, executing a parameter correction process for correcting the printing parameter set in the printing device; wherein
the initial parameter setting process includes:
the control device deriving the target printing parameter based on the registered characteristic data, a target image density, and a parameter calculation constant; and
the control device setting the derived target printing parameter in the printing device; and
the parameter correction process includes:
the control device causing the printing device to execute a process of forming the test toner image in an invalid area on the surface of the image-carrying member other than a transfer area where the toner image is transferred onto each of the plurality of sheets;
the control device converting the registered characteristic data into target characteristic data corresponding to the target printing speed based on detected density of the test toner image detected by the density detection device;
the control device deriving a corrected target printing parameter based on the target characteristic data and the target image density; and
the control device setting the corrected target printing parameter in the printing device.

### Supplementary Note 2

The image forming apparatus control method according to Supplementary Note 1 including,
in a case in which the target printing speed is the same as the specific printing speed corresponding to the registered characteristic data,
the control device, when the printing job in which the image-carrying member is rotated at a speed corresponding to the target printing speed while transferring an image to each of the plurality of sheets, setting a first specific printing parameter corresponding to the target image density in the printing parameter of the registered characteristic data as the target printing parameter in the printing device.

### Supplementary Note 3

The image forming apparatus control method according to Supplementary Notes 1 or 2 including
the control device associating the target characteristic data with the target printing speed and setting the target characteristic data as the registered characteristic data.

### Supplementary Note 4

The image forming apparatus control method according to any one of Supplementary Notes 1 to 3, wherein
the parameter calculation constant is an offset value representing a difference between the printing parameter of the registered characteristic data and a first specific printing parameter corresponding to the target image density;
the initial parameter setting process includes:
the control device deriving a difference between the first specific printing parameter and the parameter calculation constant as the target printing parameter; and
the parameter correction process includes:
the control device converting the registered characteristic data into the target characteristic data based on a ratio between a reference image density corresponding to the target printing parameter in the output image density of the registered characteristic data and the detected density of the test toner image; and
the control device deriving a second specific printing parameter corresponding to the target image density in the printing parameter of the target characteristic data as the corrected target printing parameter.

### Supplementary Note 5

The image forming apparatus control method according to any one of Supplementary Notes 1 to 4, wherein
the printing device includes:
a plurality of photoconductors each rotating;
a charging device including a plurality of charged members arranged opposite to the plurality of photoconductors, and configured to apply a charging voltage to the plurality of charged members to charge surfaces of the plurality of photoconductors;
a laser scanning unit configured to scan a beam of light on a charged surface of each of the plurality of photoconductors to form an electrostatic latent image on the surface of each of the plurality of photoconductors;
a developing device including a plurality of developing members each carrying a toner and arranged opposite each of the plurality of photoconductors, and configured to apply a developing voltage to the plurality of developing members to develop the electrostatic latent image into the toner image; and
a transfer device including the image-carrying member, and configured to transfer the toner image from the plurality of photoconductors to the image-carrying member, and further transfer the toner image from the image-carrying member to each of the plurality of sheets; and
the printing parameter includes the charging voltage of the charging device, a light beam amount of the laser scanning unit, the developing voltage of the developing device, or a timing parameter that adjusts the timing in the laser scanning unit of scanning the light beam on each of the plurality of photoconductors.

### Supplementary Note 6

The image forming apparatus control method according to any one of Supplementary Notes 1 to 4, wherein
the printing device includes:
a charging device including a charging member arranged opposite the image-carrying member, and configured to apply a charging voltage to the charging member to charge the surface of the image-carrying member;
a laser scanning unit configured to form an electrostatic latent image on a surface of the image-carrying member by scanning a beam of light on a charged surface of the image-carrying member;
a developing device including a developing member that carries toner and is arranged opposite the image-carrying member, and configured to apply a developing voltage to the developing member and develop the electrostatic latent image into the toner image; and
a transfer device configured to transfer the toner image from the image-carrying member to each of the plurality of sheets; and
the printing parameter includes the charging voltage of the charging device, the light beam amount of the laser scanning unit, or the developing voltage of the developing device.

### Supplementary Note 7

The image forming apparatus control method according to any one of Supplementary Notes 1 to 6 including
the control device executing the parameter correction process each time a predetermined condition related to a number of prints or the elapsed time is met while the printing job is being executed.

### Supplementary Note 8

An image forming apparatus, including:
a printing device including a rotating image-carrying member and configured to form a toner image on a surface of the image-carrying member, and transfer the toner image on the image-carrying member onto each of a plurality of sheets conveyed along a conveying path;
a density detection device configured to detect density of a test toner image formed on a surface of the image-carrying member; and
a control device configured to implement the image forming apparatus control method according to any one of Supplementary Notes 1 to 7.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus control method for controlling an image forming apparatus,
the image forming apparatus, comprising:
a printing device including a rotating image-carrying member and configured to form a toner image on a surface of the image-carrying member, and transfer the toner image on the image-carrying member onto each of a plurality of sheets conveyed along a conveying path; and
a density detection device configured to detect density of a test toner image formed on a surface of the image-carrying member;
the image forming apparatus control method comprising:
in a case in which registered characteristic data representing a correspondence relationship between a printing parameter of the printing device and output image density is associated with a specific printing speed,
a control device, when a printing job is started in which an image is transferred onto each of the plurality of sheets while rotating the image-carrying member at a speed corresponding to a target printing speed different from the specific printing speed, executing an initial parameter setting process to initially set a target printing parameter corresponding to the target printing speed in the printing device; and
the control device, while the printing job is being executed, executing a parameter correction process for correcting the printing parameter set in the printing device; wherein
the initial parameter setting process comprises:
the control device deriving the target printing parameter based on the registered characteristic data, a target image density, and a parameter calculation constant; and
the control device setting the derived target printing parameter in the printing device; and
the parameter correction process comprises:
the control device causing the printing device to execute a process of forming the test toner image in an invalid area on the surface of the image-carrying member other than a transfer area where the toner image is transferred onto each of the plurality of sheets;
the control device converting the registered characteristic data into target characteristic data corresponding to the target printing speed based on detected density of the test toner image detected by the density detection device;
the control device deriving a corrected target printing parameter based on the target characteristic data and the target image density; and
the control device setting the corrected target printing parameter in the printing device.

2. The image forming apparatus control method according to claim 1 comprising,
in a case in which the target printing speed is the same as the specific printing speed corresponding to the registered characteristic data,
the control device, when the printing job in which the image-carrying member is rotated at a speed corresponding to the target printing speed while transferring an image to each of the plurality of sheets, setting a first specific printing parameter corresponding to the target image density in the printing parameter of the registered characteristic data as the target printing parameter in the printing device.

3. The image forming apparatus control method according to claim 1, comprising
the control device associating the target characteristic data with the target printing speed and setting the target characteristic data as the registered characteristic data.

4. The image forming apparatus control method according to claim 1, wherein
the parameter calculation constant is an offset value representing a difference between the printing parameter of the registered characteristic data and a first specific printing parameter corresponding to the target image density;
the initial parameter setting process comprises
the control device deriving a difference between the first specific printing parameter and the parameter calculation constant as the target printing parameter; and
the parameter correction process comprises
the control device converting the registered characteristic data into the target characteristic data based on a ratio between a reference image density corresponding to the target printing parameter in the output image density of the registered characteristic data and the detected density of the test toner image; and
the control device deriving a second specific printing parameter corresponding to the target image density in the printing parameter of the target characteristic data as the corrected target printing parameter.

5. The image forming apparatus control method according to claim 1, wherein
the printing device comprises:
a plurality of photoconductors each rotating;
a charging device including a plurality of charged members arranged opposite to the plurality of photoconductors, and configured to apply a charging voltage to the plurality of charged members to charge surfaces of the plurality of photoconductors;
a laser scanning unit configured to scan a beam of light on a charged surface of each of the plurality of photoconductors to form an electrostatic latent image on the surface of each of the plurality of photoconductors;
a developing device including a plurality of developing members each carrying a toner and arranged opposite each of the plurality of photoconductors, and configured to apply a developing voltage to the plurality of developing members to develop the electrostatic latent image into the toner image; and
a transfer device including the image-carrying member, and configured to transfer the toner image from the plurality of photoconductors to the image-carrying member, and further transfer the toner image from the image-carrying member to each of the plurality of sheets; and
the printing parameter includes the charging voltage of the charging device, a light beam amount of the laser scanning unit, the developing voltage of the developing device, or a timing parameter that adjusts the timing in the laser scanning unit of scanning the light beam on each of the plurality of photoconductors.

6. The image forming apparatus control method according to claim 1, wherein
the printing device comprises:
a charging device including a charging member arranged opposite the image-carrying member, and configured to apply a charging voltage to the charging member to charge the surface of the image-carrying member;
a laser scanning unit configured to form an electrostatic latent image on a surface of the image-carrying member by scanning a beam of light on a charged surface of the image-carrying member;
a developing device including a developing member that carries toner and is arranged opposite the image-carrying member, and configured to apply a developing voltage to the developing member and develop the electrostatic latent image into the toner image; and
a transfer device configured to transfer the toner image from the image-carrying member to each of the plurality of sheets; and
the printing parameter includes the charging voltage of the charging device, the light beam amount of the laser scanning unit, or the developing voltage of the developing device.

7. The image forming apparatus control method according to claim 1, comprising
the control device executing the parameter correction process each time a predetermined condition related to a number of prints or the elapsed time is met while the printing job is being executed.

8. An image forming apparatus, comprising:
a printing device including a rotating image-carrying member and configured to form a toner image on a surface of the image-carrying member, and transfer the toner image on the image-carrying member onto each of a plurality of sheets conveyed along a conveying path;
a density detection device configured to detect density of a test toner image formed on a surface of the image-carrying member; and
a control device configured to implement the image forming apparatus control method according to claim 1.
